(19) United States
(12) Patent Application Publication
(10) Pub. No.: US 2006/0134401 A1
(43) Pub. Date: Jun. 22, 2006

(54) Multi-layer material

(76) Inventor: Tzong In Yeh, Fremont, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/270,492

(22) Filed: Nov. 10, 2005

Related U.S. Application Data
(63) Continuation-in-part of application No. 11/018,430, filed on Dec. 20, 2004.
(63) Continuation-in-part of application No. 11/103,861, filed on Apr. 12, 2005.

(51) Int. Cl. B32B 3/00

(52) U.S. Cl. 428/316.6; 428/319.3; 428/319.7; 428/317.1; 428/317.7

(57) ABSTRACT

A multi-layer material mainly comprises an ionomer resin layer, a first bonding layer, a foam layer, a second bonding layer and a fabric layer. The first bonding layer is heat laminated to the ionomer resin layer. The foam layer made of an expanded polyethylene foam sheet or a blended foam sheet of polyethylene and ethylene vinyl acetate (EVA) is heat laminated to the first bonding layer. Additionally, the second bonding layer is laminated to the foam layer and the fabric layer is laminated to the second bonding layer. Furthermore, the first bonding layer is preferably a copolymer layer/agent and the second bonding layer is preferably an adhesive layer or a polyethylene layer.

### CROSS REFERENCE TO RELATED APPLICATION

This application is a continuation-in-part application of co-pending U.S. application Ser. No. 11/018,430 filed Dec. 20, 2004, and is a continuation-in-part application of the co-pending U.S. Ser. No. 11/103,861 application, filed on Apr. 12, 2005.

### TECHNICAL FIELD

This invention relates generally to a multi-layer material, which is not only provided for manufacturing cases, such as suitcases, luggage, tool cases, musical instrument cases, but also for manufacturing pads, mats, toys, bags and sporting goods etc.

### BACKGROUND OF THE INVENTION

For the manufacturers of suitcases, luggage and cases, casing materials with lightweight, strong structure and low cost are in substantial demand. Generally speaking, one conventional casing material for suitcases or luggage is made of a composite metal, which is strong in structure but heavy in weight, also expensive in cost. Another conventional casing material is made of multi-layer plastic material, which is lighter in weight and cheaper in cost but poorer in structure, compared with the composite metal. For example, an acrylonitrile butadiene styrene (ABS) material is a popular material for manufacturing suitcases, luggage and so on. The ABS material has a nature of wear resistance but limited. In addition, the suitcases made of the ABS material are easily deformed and the edges of the suitcases are also easily broken, after the impact between the suitcases during transportation.

Additionally, for the manufacturers of sport goods, such as sport boards, a multi-layer material is generally provided for covering outer surfaces of a core of the sport board. In U.S. Pat. No. 5,211,593, a foam-core structure with graphics-imprinted skin is disclosed. The skin is provided for bonding to a surface of the core and includes a plurality of plastic layers. Furthermore, U.S. Pat. No. 6,908,351 further discloses a sport board having composite skins, namely layered skins. Each of the skins basically includes a sheet of a polyolefin material, a polyethylene foam sheet and a blended sheet of expanded polystyrene and polyethylene.

### SUMMARY OF INVENTION

The primary objective of the present invention is to provide a multi-layer material with advantages of lightweight, strong structure and low cost. The multi-layer material not only is provided for manufacturing various cases, such as suitcases, luggage, tool boxes etc., but also for manufacturing pads, mats, toys, bags, sporting goods and so on.

More specifically, in one embodiment of the present invention, the multi-layer material mainly comprises an ionomer resin layer, a first bonding layer, a foam layer, a second bonding layer and a fabric layer. The first bonding layer is heat laminated to the ionomer resin layer, which is known as a Surlyn layer. The foam layer made of an expanded polyethylene foam sheet or a blended foam sheet of polyethylene and ethylene vinyl acetate (EVA) is heat laminated to the first bonding layer. The first bonding layer is a copolymer layer/agent provided for heat bonding the ionomer resin layer and the foam layer. Additionally, the second bonding layer is laminated to the foam layer and finally the fabric layer is laminated to the second bonding layer. Furthermore, the second bonding layer is an adhesive layer or a polyethylene layer provided for bonding the foam layer and the fabric layer.

For a further application to the present invention, the ionomer resin layer of the multi-layer material can be replaced by a thermoplastic polyurethane (TPU) layer, which has great characteristics of tear resistance, low temperature flexibility, and wear resistance as well. Moreover, a visible graphic layer, such as a colored design layer, could be laminated between the foam layer and the first bonding layer, so as to improve the appearance of a specific product when the multi-layer material is applied to the product.

### BRIEF DESCRIPTION OF DRAWINGS

The invention will be more clearly understood after referring to the following detailed description read in conjunction with the drawings wherein:

FIG. 1 is a perspective view of a first embodiment of the present invention, showing a multi-layer material;

FIG. 2 is a cross sectional view of the first embodiment of the present invention;

FIG. 3 is a perspective view of a second embodiment of the present invention, showing a multi-layer material further comprising a visible graphic layer;

FIG. 4 is a perspective view of the second embodiment of the present invention, showing the visible graphic layer comprising two plastic films and graphics formed between; and

FIG. 5 is a perspective view of the second embodiment of the present invention, showing the visible graphic layer being laminated between an ionomer resin layer and a first bonding layer.

### DETAILED DESCRIPTION OF PREFERRED EMBODIMENTS

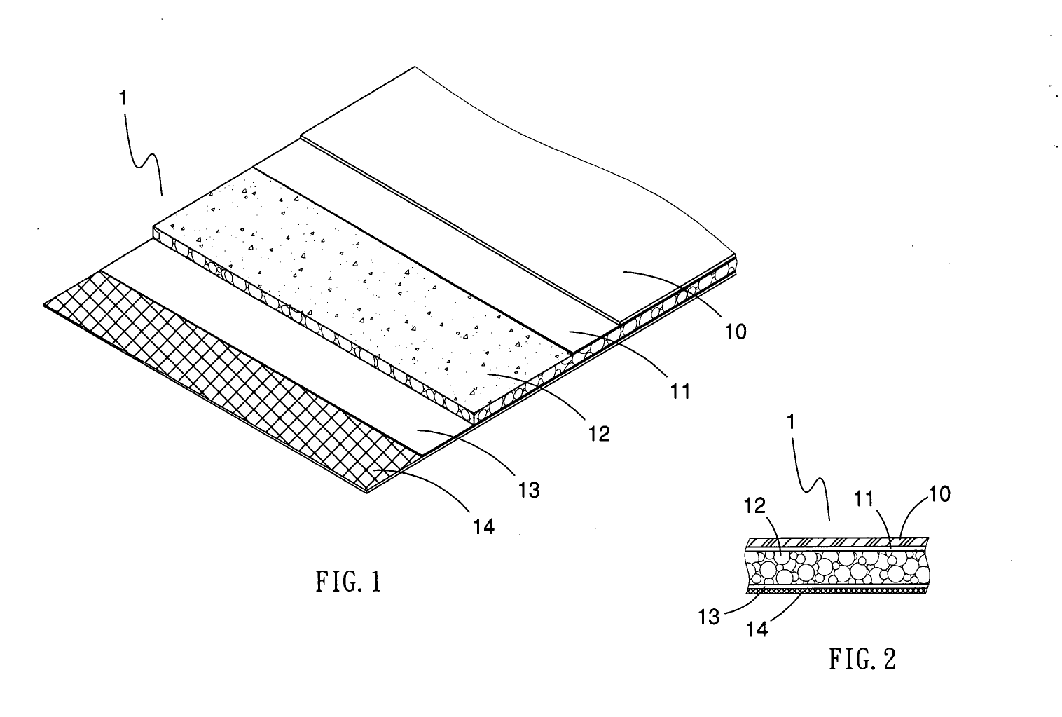

FIG. 1 and FIG. 2 show a multi-layer material 1 as a first embodiment of the present invention and the multi-layer material 1 comprises an ionomer resin layer 10, a first bonding layer 11, a foam layer 12, a second bonding layer 13 and a fabric layer 14. As shown in FIG. 1, the first bonding layer 11 is heat laminated to a bottom surface of the ionomer resin layer 10, which is known as a Surlyn® layer manufactured by Dupont Corporation. Preferably, the ionomer resin layer 10 has a thickness in a range of 0.1 to 2 mm. Furthermore, the foam layer 12 is heat laminated to the first bonding layer 11. The foam layer 12 is but not limited to an expanded polyethylene foam sheet or a blended foam sheet of polyethylene and ethylene vinyl acetate (EVA) in the present invention. The expanded polyethylene foam sheet has a density in a range of 1.5 to 12 PCF and a thickness in a range of 1 to 6 mm that is presently preferred as the foam layer 12. Additionally, the first bonding layer 11 is preferably a copolymer layer/agent, which is provided for heat bonding between the ionomer resin layer 10 and the foam layer 12, and is preferably pre-extruded and pre-coated on a surface of the foam layer 12 before lamination processes. The first bonding layer 11 has a thickness in range of 0.01 to 0.1 mm, preferably in range of 0.03 to 0.05 mm.

Additionally, the second bonding layer 13 is laminated to the foam layer 12 and finally the fabric layer 14 is laminated to the second bonding layer 13. In the present invention, the second bonding layer 13 is preferably an adhesive layer or a polyethylene layer that is provided for bonding the foam layer 12 and the fabric layer 14 mechanically. When the polyethylene layer is applied as the second bonding layer 13, the polyethylene layer is capable of thermally laminating to the foam layer 12 and mechanically laminating to the fabric layer 13. Preferably, the second bonding layer 13 has a thickness in range of 0.03 to 0.3 mm, and the fabric layer 14 is a flexible fabric material, such as woven, jersey, velour and nylon fabric materials.

More importantly, the ionomer resin layer 10 of the multi-layer material 1 has outstanding characteristics of scratch/wear resistance and transparency. For a further application to the present invention, the ionomer resin layer 10 of the multi-layer material 1 could be replaced by a thermoplastic polyurethane (TPU) layer, which has great characteristics of tear resistance, low temperature flexibility, and wear resistance as well. Other suitable plastic layers are also applicable to the present invention but the ionomer resin layer 10 and the TPU layer for the multi-layer material 1 of the present invention are preferred.

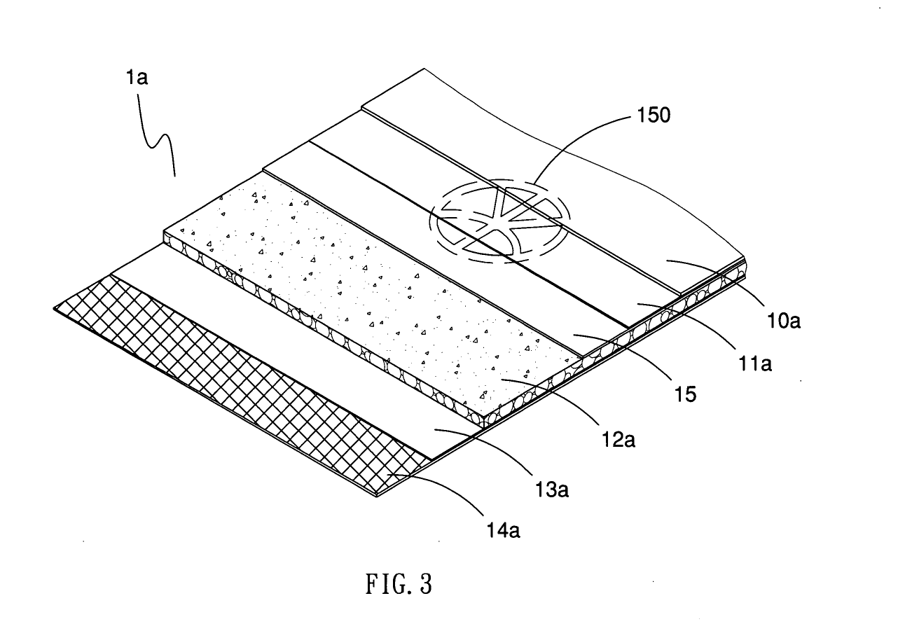

FIGS. 3-5 further show a multi-layer material 1a as a second embodiment of the present invention and the multi-layer material 1a mainly comprises an ionomer resin layer 10a, a first bonding layer 11a, a visible graphic layer 15, a foam layer 12a, a second bonding layer 13a and a fabric layer 14a. In FIG. 3, the first bonding layer 11a is heat laminated to a bottom surface of the ionomer resin layer 10a, namely the Surlyn® layer. The visible graphic layer 15 is heat laminated to the first bonding layer 11a and graphics 150 of the graphic layer 15 are visible from outside of the ionomer resin layer 10a. Furthermore, the foam layer 12a is heat laminated to the graphic layer 15 and the second bonding layer 13a is laminated to the foam layer 12a. Finally, the fabric layer 14a is laminated to the second bonding layer 13a.

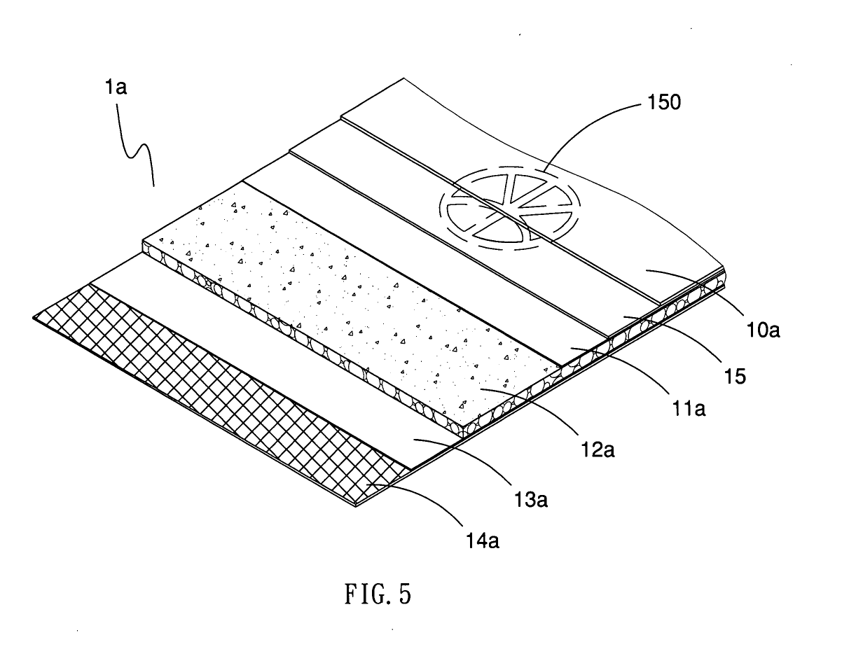

The ionomer resin layer 10a, the first bonding layer 11a, the foam layer 12a, the second bonding layer 13a, and the fabric layer 14a of the second embodiment are substantially the same as the ionomer resin layer 10, the first bonding layer 11, the foam layer 12, the second bonding layer 13, and the fabric layer 14 of the first embodiment, except the visible graphic layer 15, which can be laminated either between the ionomer resin layer 10 and the first bonding layer 11 or between the foam layer 12a and the first bonding layer 11a in the second embodiment as shown in FIG. 3 and FIG. 5. Preferably, the visible graphic layer 15 is laminated between the foam layer 12a and the first bonding layer 11a. Furthermore, the visible graphic layer 15 is but not limited to a layer with graphics 150 or a colored layer with graphics 150.

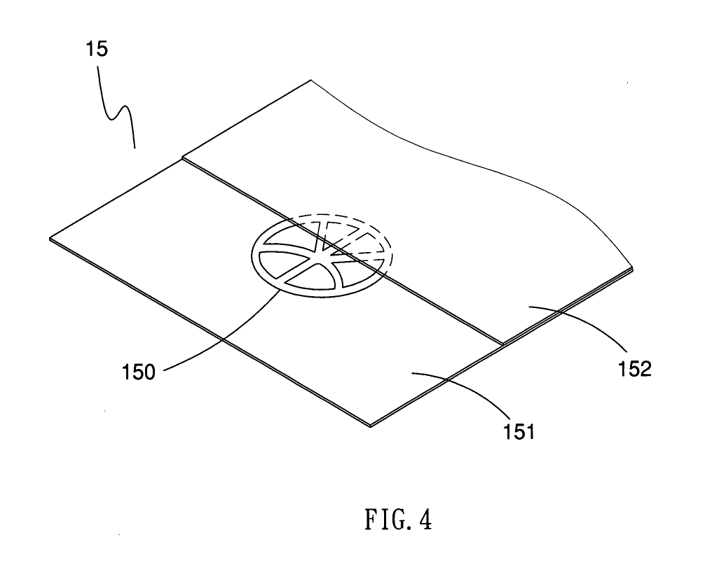

FIG. 4 further shows the visible graphic layer 15 comprises a first plastic film 151, a second plastic film 152 and graphics 150. The graphics 150 are formed between the first plastic film 151 and the second plastic film 152. Preferably, the first plastic film 151 and the second plastic film 152 are polyethylene films and are optionally selected from transparent, semi-transparent or opaque films as long as the graphics could be seen from outside of the ionomer resin layer. Additionally, the graphics 150 can be formed by any conventional technologies onto either the first plastic film 151 or the second plastic film 152. In the second embodiment of the present invention, the graphics 150 are preferably printed on a surface of the first plastic film 151 and the graphics 150 are sandwiched by the first plastic film 151 and the second plastic film 152 when the second plastic film 152 are heat laminated to the surface of the first plastic film 151. Optionally, the visible graphic layer 15 can comprise one plastic film and graphics, which are printed on one surface of the plastic film. Besides, the first plastic film 151 and the second plastic film 152 preferably have a thickness in range of 0.01 to 0.15 mm respectively.

According to the foregoing descriptions, the multi-layer materials 1, 1a of the present invention are applicable to various industries as coverings, and have advantages of lightweight, strong structure and low cost. In addition, the multi-layer material 1a with the graphic layer 15 also enhances its product appearance.

Numerous characteristics and advantages of the invention have been set forth in the foregoing description, together with details of the structure and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extent indicated by the broad general meaning of the terms in which the appended claims are expressed.

We claim:

1. A multi-layer material comprising:
an ionomer resin layer;
a first bonding layer, heat laminated to the ionomer resin layer;
a foam layer, heat laminated to the first bonding layer;
a second bonding layer, laminated to the foam layer; and
a fabric layer, laminated to the second bonding layer.

2. The multi-layer material of claim 1, wherein the foam layer is an expanded polyethylene foam sheet, the first bonding layer is a copolymer layer and the second bonding layer is an adhesive layer.

3. The multi-layer material of claim 1, wherein the foam layer is an expanded polyethylene foam sheet, the first bonding layer is a copolymer layer and the second bonding layer is a polyethylene layer.

4. The multi-layer material of claim 1, wherein the foam layer is a blended foam sheet of expanded polyethylene and ethylene vinyl acetate, the first bonding layer is a copolymer layer and the second bonding layer is an adhesive layer.

5. The multi-layer material of claim 1, wherein the foam layer is a blended foam sheet of expanded polyethylene and ethylene vinyl acetate, the first bonding layer is a copolymer layer and the second bonding layer is a polyethylene layer.

6. A multi-layer material comprising:
a thermoplastic polyurethane layer;
a first bonding layer, heat laminated to the thermoplastic polyurethane layer;
a foam layer, heat laminated to the first bonding layer;
a second bonding layer, laminated to the foam layer; and
a fabric layer, laminated to the second bonding layer.

7. The multi-layer material of claim 6, wherein the foam layer is an expanded polyethylene foam sheet, the first bonding layer is a copolymer layer and the second bonding layer is an adhesive layer.

8. The multi-layer material of claim 6, wherein the foam layer is an expanded polyethylene foam sheet, the first bonding layer is a copolymer layer and the second bonding layer is a polyethylene layer.

9. The multi-layer material of claim 6, wherein the foam layer is a blended foam sheet of expanded polyethylene and ethylene vinyl acetate, the first bonding layer is a copolymer layer and the second bonding layer is an adhesive layer.

10. The multi-layer material of claim 6, wherein the foam layer is a blended foam sheet of expanded polyethylene and ethylene vinyl acetate, the first bonding layer is a copolymer layer and the second bonding layer is a polyethylene layer.

11. A multi-layer material comprising:
an ionomer resin layer;
a bonding layer, heat laminated to the ionomer resin layer;
a visible graphic layer, heat laminated to the bonding layer; and
a foam layer, heat laminated to the graphic layer.

12. The multi-layer material of claim 11, wherein the visible graphic layer comprises:
a first plastic film;
graphics, formed on a surface of the first plastic film; and
a second plastic film, heat laminated to the surface of the first plastic film so as to cover the graphics; and
wherein the foam layer is an expanded polyethylene foam sheet and the bonding layer is a copolymer layer.

13. The multi-layer material of claim 11, wherein the visible graphic layer comprises:
a first plastic film;
graphics, formed on a surface of the first plastic film; and
a second plastic film, heat laminated to the surface of the first plastic film so as to cover the graphics; and
wherein the foam layer is a blended foam sheet of expanded polyethylene and ethylene vinyl acetate and the bonding layer is a copolymer layer.

14. The multi-layer material of claim 12, further comprising a fabric layer laminated to the foam layer by an adhesive layer.

15. The multi-layer material of claim 13, further comprising a fabric layer laminated to the foam layer by an adhesive layer.

16. The multi-layer material of claim 12, further comprising a fabric layer laminated to the foam layer by a polyethylene layer.

17. The multi-layer material of claim 13, further comprising a fabric layer laminated to the foam layer by a polyethylene layer.

18. A multi-layer material comprising:
an ionomer resin layer;
a visible graphic layer, heat laminated to the ionomer resin layer;
a bonding layer, heat laminated to the visible graphic layer; and
a foam layer, heat laminated to the bonding layer.

19. The multi-layer material of claim 18, wherein the visible graphic layer comprises:
a first plastic film;
graphics, formed on a surface of the first plastic film; and
a second plastic film, heat laminated to the surface of the first plastic film so as to cover the graphics; and
wherein the foam layer is an expanded polyethylene foam sheet and the bonding layer is a copolymer layer.

20. The multi-layer material of claim 18, wherein the visible graphic layer comprises:
a first plastic film;
graphics, formed on a surface of the first plastic film; and
a second plastic film, heat laminated to the surface of the first plastic film so as to cover the graphics; and
wherein the foam layer is a blended foam sheet of expanded polyethylene and ethylene vinyl acetate and the bonding layer is a copolymer layer.

21. The multi-layer material of claim 19, further comprising a fabric layer laminated to the foam layer by an adhesive layer.

22. The multi-layer material of claim 20, further comprising a fabric layer laminated to the foam layer by an adhesive layer.

23. The multi-layer material of claim 19, further comprising a fabric layer laminated to the foam layer by a polyethylene layer.

24. The multi-layer material of claim 20, further comprising a fabric layer laminated to the foam layer by a polyethylene layer.
